(19) United States
(12) Patent Application Publication
(10) Pub. No.: US 2017/0083909 A1
(43) Pub. Date: Mar. 23, 2017

(54) INTERNAL VAULT STORAGE OF TOKENS FOR ACCOUNT IDENTIFICATION

(71) Applicant: Bank of America Corporation, Charlotte, NC (US)

(72) Inventors: Phillip Wade Mork, Huntersville, NC (US); Srinivas Dundigalla, Charlotte, NC (US); Joseph Benjamin Castinado, North Glenn, CO (US)

(21) Appl. No.: 14/861,642

(22) Filed: Sep. 22, 2015

(51) Int. Cl. G06Q 20/38; G06Q 20/32; G06Q 20/40

(52) U.S. Cl. CPC G06Q 20/3825; G06Q 20/401; G06Q 20/327; G06Q 2220/00

(57) ABSTRACT

Embodiments of the invention are directed to systems, methods, and computer program products for authorizing a financial transaction based on receiving a wearable device token. The invention may be configured for identifying a financial account maintained by a financial institution, wherein the financial account is associated with a transaction card used to conduct transactions using the financial account; generating the wearable device token that identifies the financial account and the financial institution; communicating and store the wearable device token on a wearable device; receiving a response token as a result of the wearable device interacting with a transaction machine to complete the financial transaction, wherein the response token comprises the wearable device token; identifying the financial institution and the financial account based on the response token; and authorizing the transaction based on receiving the response token.

### BACKGROUND

Consumers are converting to the use of digital wallets as a supplement or alternative to traditional payment methods. Digital wallets provide a means for storing payment credentials associated with consumer accounts that are maintained by financial institutions. In this way, the consumers can access their digital wallets to process transactions, as opposed to having a physical payment medium such as a debit card in their possession.

### BRIEF SUMMARY

Embodiments of the invention are directed to systems, methods, and computer program products for authorizing a financial transaction based on receiving a wearable device token.

In some embodiments, the invention is configured to identify a financial account maintained by a financial institution. The financial account is typically associated with a transaction card used to conduct transactions using the financial account.

In some embodiments, the invention is configured to generate a wearable device token that identifies the financial account and the financial institution. The invention communicates the wearable device token to a wearable device associated with a user of the financial account. The wearable device token is stored on the wearable device.

In some embodiments, the invention receives a response token as a result of the wearable device interacting with a transaction machine to complete a transaction. The response token comprises information related to the wearable device token.

While in other embodiments, the invention identifies the financial institution and the financial account based on the response token and performs the transaction based on receiving the response token.

In other embodiments, the user is associated with multiple financial accounts. The invention generates two or more wearable tokens that each identifies separate accounts of the user and a financial institution for each of the separate accounts. The invention may then communicate the two or more wearable device tokens to the wearable device associated with the user. Based on these wearable device tokens, the invention may enable the user to select one of the two or more wearable device tokens to complete the transaction. The invention may then receive a response token comprising information related to the selected wearable device token, wherein receiving the response is a result of the wearable device interacting with the transaction machine to complete a transaction. Finally, the invention may be configured to perform the transaction based on receiving the response token comprising information related to the selected wearable device token.

In other embodiments, the invention may be configured to transmit code executable by the wearable device that causes the wearable device to sense the user physically possesses the wearable device. Sensing the user physically possesses the wearable device is based on the wearable device monitoring actions performed by the user. The code may further cause the wearable device to communicate an indication that the user physically possesses the wearable device and receive the indication that the user physically possesses the wearable device. Further, performing the transaction is further based on determining the user physically possesses the wearable device.

In other embodiments, the invention may be configured to receive, from a transaction machine, an authentication credential. The authentication credential is received as a result of the user entering in the authentication credential to the transaction machine. The invention may further authenticate the user using the authentication credential; and perform the transaction based on authenticating the user.

In other embodiments, the invention may be further configured to register the wearable device as associated with the wearable device token based at least on a unique identification associated with the wearable device.

While in other embodiments, the invention may be further configured to authenticate the wearable device when receiving the response token using the unique identification associated with the wearable device and perform the transaction based on authenticating the wearable device.

In some embodiments, the wearable device token is a single-use token. Using a single-use token, the invention may be configured to receive a second response token comprising information related to the single-use token. The second response token is received after performing the transaction. The invention may be further configured to cancel a second transaction associated with the second response token based on receiving the second response token after performing the transaction.

In other embodiments, the wearable device token has an associated limitation restricting performance of the transaction. Based on this limitation, the invention may be configured to determine whether the transaction is subject to the limitation. The system may be further configured to perform the transaction if the limitation does not apply.

### BRIEF DESCRIPTION OF THE DRAWINGS

Having thus described embodiments of the invention in general terms, reference will now be made to the accompanying drawings, where:

FIG. 1 is a diagram illustrating a token management system, in accordance with embodiments of the present invention;

FIG. 2 is a flow chart illustrating a general process flow for authorizing a financial transaction based on receiving a wearable device token, in accordance with various embodiments of the invention;

FIG. 3 is a mixed block and flow diagram of an apparatus for authorizing a financial transaction based on receiving a wearable device token, in accordance with several embodiments of the present invention; and

FIG. 4 is a flow chart illustrating a detailed process flow for authenticating a token, in accordance with various embodiments of the invention.

### DETAILED DESCRIPTION OF EMBODIMENTS OF THE INVENTION

Embodiments of the invention are directed to systems, methods, and computer program products for authorizing a financial transaction based on receiving a wearable device token. Embodiments of the present invention may now be described more fully hereinafter with reference to the accompanying drawings, in which some, but not all, embodiments of the invention are shown. Indeed, the invention may be embodied in different forms and should not be construed as limited to the embodiments set forth herein. Rather, these embodiments are provided so that this disclosure may satisfy applicable legal requirements. Like numbers refer to like elements throughout.

A user may have an account that has an associated transaction card. The transaction card is used to perform transactions using funds of the account. Alternative to using a transaction card, the invention enables the user to perform transactions on the account without using the transaction card but instead a wearable device. To accomplish this, the invention generates one or more wearable device tokens that are communicated to a wearable device. The wearable device tokens are associated with one or more financial accounts of the user. The wearable device receives such wearable device tokens that are stored in memory of the wearable device. The wearable device itself may be a phone, a smart watch, or even an article or clothing with a built-in wearable technology. Generally, the wearable device will have a communication interface that allows the wearable device to receive the token. The wearable device will further include memory for storing the token and additional executable code, and a processor. Further, in addition to the communication interface used to receive the wearable device token, the wearable device may further include a second communication interface that allows the wearable device token to interact with a transaction machine to complete a financial transaction. The communication interface may be a Near Field Communication (NFC) device, an RF module, and the like. The system may also install an application on the wearable device that directs the wearable device how to communicate with and complete transactions by interfacing with the transaction machine. When a user desires to complete a transaction, the user interfaces the wearable device with the transaction machine. Interfacing may be accomplished based on the second communication device. For example, if the second communication device is an NFC device, the user may hold the wearable device proximate to an NFC transmitter on the transaction machine. The wearable device and transaction machine may perform a pairing process to identify one another. After the pairing process is complete, the application stored on the wearable device may generate a response token that includes information of the wearable device token, thus allowing a system that receives the response token to be able to identify the account associated with the wearable device token. The response token may further include additional information about the wearable device and the like. The transaction machine may receive the response token and further update the response token with additional information. This information may include a merchant identifier, details of the transaction and the like. The transaction machine may then communicate with a system to transfer the response token. The system identifies transaction details and an account associated with the response token. The system may validate the response token. After determining the account associated with the response token and the details of the transaction, the system may perform the transaction. The system may further send a response back to the transaction machine stating the transaction was performed.

To provide security in the process, the application may cause the wearable device to authenticate a user prior to generating and communicating the response token. The wearable device may be able to sense when it is worn or possessed by the user. When the wearable device is first worn or possessed by the user, the wearable device may instruct the user to become authenticated. For example, the wearable device may ask the user to enter a username and password or a personal identification number (PIN). Based on these credentials, the wearable device may authenticate the user. After authenticating the user, the wearable device may be instructed to monitor constantly whether the wearable device is in the possession of the user (e.g. worn on the wrist of the user). As long as the wearable device remains in the possession of the user, the user remains authenticated with the wearable device. In the event, the wearable device is separated from the user, the initial authentication ends. Therefore, when a user attempts to conduct a transaction, if the user is authenticated, the wearable device may generate the response token and communicate such to the transaction machine. If at any time prior to conducting the transaction, the authentication is lost without being reestablished, the wearable device may refuse to generate the response token. In some embodiments of the invention, the wearable device may not have features that would enable a user to submit authentication credentials. The wearable device may be configured to connect to and communicate with a second device (e.g. a mobile device) that would allow the user to enter the authentication credentials that would be used by the wearable device to authenticate the user. Further, in such an instance, the wearable device may receive an indication that the user was authenticated. In addition to the user being authenticated with the wearable device, the transaction machine may request the user become authenticated during the transaction. After receiving the response token, the transaction machine may request the user to supply authentication credentials. The transaction machine may update the response token with the authentication credentials.

An additional feature of the invention may enable the wearable device to store multiple wearable device tokens, each of which may be used to complete a transaction, and enable a user to select one of the wearable device tokens stored on the wearable device to complete a transaction. The application stored on the wearable device may cause the wearable device to present a graphical user interface to the user that displays the wearable device tokens. The wearable device may further enable input controls to allow the user to select one of the wearable device tokens. Thus, when the user conducts a transaction, the wearable device generates the response token based on the selected wearable device token. Alternatively, the invention may generate a graphical user interface that may be displayed on a device other than the wearable device. The graphical user interface would allow the user to select the wearable device token from a list of wearable device tokens. The device displaying the graphical user interface may transmit a request to update the selected wearable device token that is received by the wearable device. The wearable device may update the selected wearable device token accordingly.

Other embodiments of the invention may allow a wearable device token to be a single-user token, wherein the token may only be used once. After a system of the invention receives a second response token based on the single-user wearable device token, the system would be configured to deny an associated transaction.

In some embodiments, an “entity” may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loans associations, credit unions, investment companies, insurance companies and the like. In some embodiments, the entity may allow a user to establish an account with the entity.

As used herein, an “account” may be the relationship that the user has with the entity. Examples of accounts include a deposit account, such as a transaction account (e.g. banking account), a savings account, an investment account, a money market account, a time deposit, a demand deposit, a pre-paid account, a credit account, a rewards account, an electronic wallet, a non-monetary user profile that includes only personal information with the user, or the like. The account is associated with and/or maintained by the entity. In other embodiments, an entity may not be a financial institution. In still other embodiments, the entity may be a merchant.

In some embodiments, a “user” may be a customer (e.g. an account holder or a person who has an account at the entity) or a potential customer (e.g. person who has submitted an application for an account, a person who is the target of marketing materials that are distributed by the entity, or a person who applies for a loan that has not yet been funded).

Aspects of the present invention relate to tokenization, which is generally described in the area of financial transactions as utilizing a “token” (e.g., an alias, substitute, surrogate, or other like identifier) as a replacement for sensitive account information, and in particular account numbers. As such, tokens or portions of tokens may be used as a stand in for a user account number, user name, pin number, routing information related to the financial institution associated with the account, security code, or other like information relating to the user account. The one or more tokens may then be utilized as a payment instrument to complete a transaction. The one or more tokens may be associated with one or more payment devices directly or within one or more digital wallets associated with the payment devices. In other embodiments, the tokens may be associated with electronic transactions that are made over the Internet instead of using a physical payment device. Utilizing a token as a payment instrument instead of actual account information, and specifically an account number, improves security, and provides flexibility and convenience in controlling the transactions, controlling accounts used for the transactions, and sharing transactions between various users.

Tokens may be single-use instruments or multi-use instruments depending on the types of controls (e.g., limits) initiated for the token, and the transactions in which the token is used as a payment instrument. Single-use tokens may be utilized once, and thereafter disappear, are replaced, or are erased, while multi-use tokens may be utilized more than once before they disappear, are replaced, or are erased.

Tokens may be 16-digit numbers (e.g., like credit, debit, or other like account numbers), may be numbers that are less than 16-digits, or may contain a combination of numbers, symbols, letters, or the like, and be more than, less than, or equal to 16-characters. In some embodiments, the tokens may be 16-characters or less to be compatible with the standard processing systems between merchants, acquiring financial institutions (e.g., merchant financial institution), card association networks (e.g., card processing companies), issuing financial institutions (e.g., user financial institution), or the like, which are used to request authorization, and approve or deny transactions entered into between a merchant (e.g., a specific business or individual user) and a user. In other embodiments of the invention, the tokens may be other types of electronic information (e.g., pictures, codes, or the like) that could be used to enter into a transaction instead of, or in addition to, using a string of characters (e.g., numbered character strings, alphanumeric character strings, symbolic character strings, combinations thereof, or the like).

In other embodiments, tokens may be used to authenticate a device. In such embodiments, the token may be created by a tokenization system and communicated for storage on the device. The device may communicate the token or a form of the token to an authentication system for authentication. The device may be configured to manipulate the token to avoid communicating the original token for security purposes. Such manipulation may be performed using an algorithm and or keys that are known to the authentication system and the device. For example, the device may employ a secure hash algorithm (SHA) to encrypt the token using a dynamic key. The device communicates the encrypted token to the authentication system. The authentication system uses the dynamic key to authenticate the encrypted token.

In some embodiments, the authentication system may not store a copy of the original token but instead may store an encrypted version of the token. The authentication system may receive a token from the device to be authentication. The authentication system just encrypt the token received from the device and compare the encrypted received token against the stored encrypted token for authentication.

The current invention is further directed towards wearable devices. As defined herein, a wearable device may be defined as wearable accessories that are enabled to process data using computer technology. The wearable device may be a watch, an article of clothing, or another mobile device such as a mobile phone, MP3 player, or Personal Digital Assistant (PDA) or the like. As such, the wearable device may comprise at least one or more processors, memory, and executable code stored in memory that is executable by the one or more processors. The wearable device might also include an interface that allows a user to provide input to the wearable device and a display for communicating information to the user. While in other embodiments, the wearable device may further comprise a communication device. The communication device may be configured to communicate over a wired or a wireless interface. Using the wired interface, the wearable device may communicate with other devices that are linked to a wired network or that communicate directly with the wired interface. For example, a first wearable device may comprise a wired interface that connects with a second wired device comprising an accelerometer. The first wearable device may communicate with the second wearable device to receive motion information of the second wearable device. Where the communication device includes a wireless interface, the wearable device may either communicate with other devices using an ad hoc pairing with the wearable device or a distributed network connection.

In other embodiments, the wearable device may include sensors or other devices. Such sensors might include biometric sensors, motion sensors and/or accelerometers, light sensors, touch sensors, environmental sensors (e.g. temperature, humidity), and the like. The wearable device may be configured to utilize these sensors to determine trigger events. For example, the wearable device may be configured to sense when a user is walking Based on this trigger event, the wearable device may be configured to perform a given function (e.g. count the number of steps taken by the user). In other embodiments, the wearable device may utilize timer-based triggers to perform a function and in particular, perform a measurement using one of the included sensors. For example, the wearable device may be configured to measure temperature every five minutes. Using the collected information, the wearable device may further analyze the information and compare such information against predefined limits. For example, if the wearable device measures temperature and senses a temperature greater than a predetermined limit, the wearable device may perform a function based on the sensed temperature exceeding the predetermined limit.

In yet other embodiments of the invention, the wearable device may be configured to receive wearable applications. As defined herein, a wearable application is defined as a program, script, function or code that is stored on the wearable device that is not part of the original programming or operating system of the wearable device but is processed by the wearable device and is capable of utilizing other hardware of the wearable device. Any given application is not essential to the proper operation of the wearable device but may add functionality to the wearable device. For example, a wearable device may include an accelerometer. Further, the wearable device contains code that directs the wearable device on how to take readings using the accelerometer. However, the wearable device may not possess the necessary code to instruct the wearable device when to take readings from the accelerometer. Thus, an application that directs the wearable device on when to take readings must be installed on the wearable device. Thus, the application does not instruct the wearable device how to interface with the accelerometer to take readings but instead, informs the wearable device to utilize code stored on the wearable device that instructs the wearable device how to interface with the accelerometer on how to take readings for the purpose of actually taking a reading. It is important to note that an external system may interface with the wearable device using an application to utilize the functionality of the wearable device. For example, a system may be configured to communicate with the wearable device through an application to receive temperature measurements sensed by the wearable device. Thus, external system may instruct the wearable device using commands to take such measurements and communicate such measurements back to the system. Thus, the wearable device may be an extension of the system. In such an environment, the wearable device might include multiple applications and therefore might be an extension of multiple systems, each of which may utilize the same hardware.

Wearable devices are becoming more prevalent in a variety of markets and industries. The devices are being used in many operations, such as but not limited to identifying a user, storage and transmission of credentials, storage and transmission of financial information, general user-data storage, and the like. In particular, wearable devices are used more and more to share user credentials and to perform financial transactions. Most wearable devices communicate data through wireless Wi-Fi, near field communication (NFC), radio frequency identification (RFID), and other wireless technologies. The future of individual identification in consumer-based industries will be led by the integration of wearable technology with authentication and identification in both physical and virtual environments. Examples of potential wearable devices that could be included in this integration are smart watches, bands, ear-pods, jewelry, eyeglasses, contact lenses, clothing, and the like.

A typical financial transaction executed by a user may require the user to present a payment vehicle (e.g., credit card, debit card, or the like) to the merchant to complete a transaction. During the process of executing the transaction, the merchant may require the user to provide additional authentication credentials to confirm the identity of the user. This may be in the form of a valid identification document, a signature, a personal identification number (PIN), or the like. Although this form of identification confirmation during the process of executing the transaction may provide a sense of trustworthiness to the merchant, it may result in unnecessary inconvenience to the user. With users performing a multitude of transactions using wearable devices in the financial industry, there is a need to ensure security and convenience. Although wearable devices may be used as a form of a payment vehicle at contactless point-of-sale terminals at merchant locations, the merchant may still have to confirm the identity of the user adorning the wearable device at every interaction to determine the trustworthiness of the user and reduce the likelihood of misrepresentation.

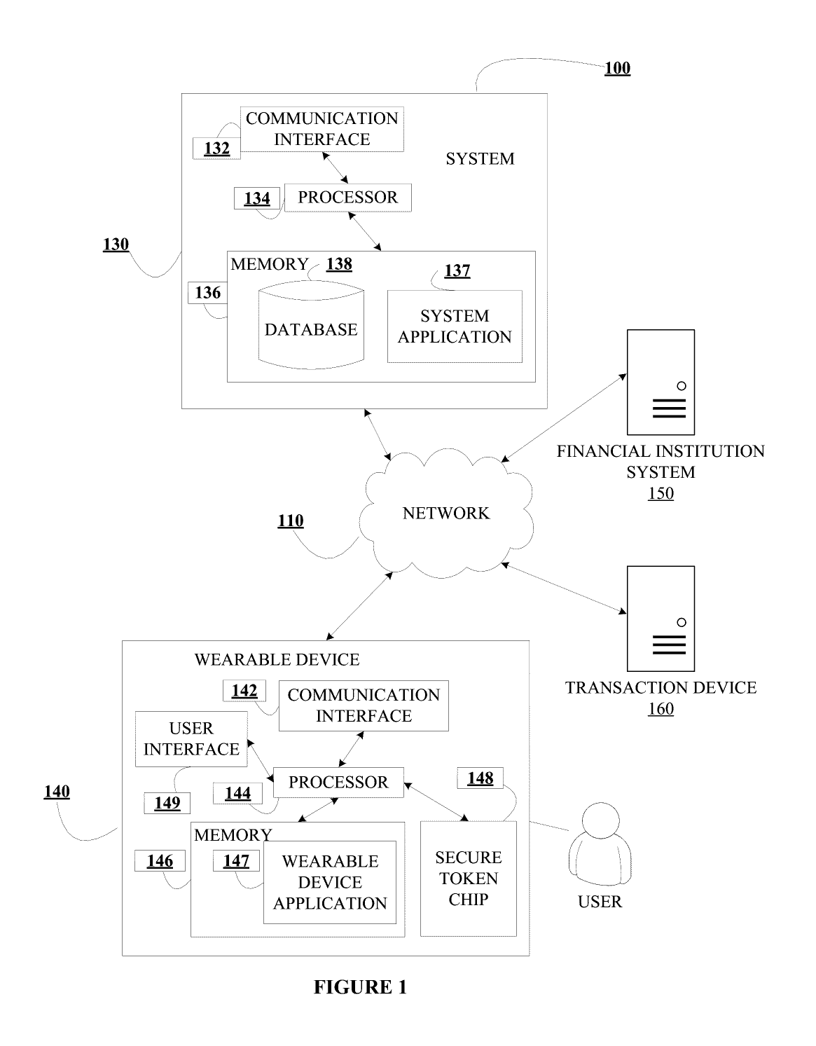

FIG. 1 presents an exemplary block diagram of the system environment 100 for implementing the process flows described herein in accordance with embodiments of the present invention. As illustrated, the system environment 100 includes a network 110, a system 130, a wearable device 140, a financial institution system 150, and a transaction device 160. Also shown in FIG. 1 is a user of the wearable device 140. The wearable device 140 may be a mobile device or other non-mobile computing device. The user may be a person who uses the wearable device 140 to perform an action that is sensed by the wearable device and processed by the data sensing packet 147. The data sensing packet 147 may be an application stored on the wearable device 140 that communicates with the system 130, perform a transaction, input information onto a user interface presented on the wearable device 140, process actions of the user, and the like. The data sensing packet 147 and/or the system application 137 may incorporate one or more parts of any process flow described herein.

As shown in FIG. 1, the system 130, the wearable device 140, the financial institution system 150, and the transaction device 160 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may include wireless and/or wired and/or optical interconnection technology.

The wearable device 140 may include any computerized apparatus that can be configured to perform any one or more of the functions of the wearable device 140 described and/or contemplated herein. For example, the user may use the wearable device 140 to transmit and/or receive information or commands to and from the system 130. In some embodiments, for example, the wearable device 140 may include a personal computer system (e.g. a non-mobile or non-portable computing system, or the like), a mobile computing device, a personal digital assistant, a mobile phone, a tablet computing device, a network device, and/or the like. As illustrated in FIG. 1, in accordance with some embodiments of the present invention, the wearable device 140 includes a communication interface 142, a processor 144, a memory 146 having a wearable device application 147 stored therein, a secure token chip 148, and a user interface 149. In such embodiments, the communication interface 142 is operatively and selectively connected to the processor 144, which is operatively and selectively connected to the secure token chip 148, the user interface 149, and the memory 146. In some embodiments, the user may use the wearable device application 147 to execute processes described with respect to the process flows described herein. Specifically, the wearable device application 147 executes the process flows described herein.

Each communication interface described herein, including the communication interface 142, generally includes hardware, and, in some instances, software, that enables the wearable device 140, to transport, send, receive, and/or otherwise communicate information to and/or from the communication interface of one or more other systems on the network 110. For example, the communication interface 142 of the wearable device 140 may include a wireless transceiver, modem, server, electrical connection, and/or other electronic device that operatively connects the wearable device 140 to another system such as the system 130. The wireless transceiver may include a radio circuit to enable wireless transmission and reception of information. Additionally, the wearable device 140 may include a positioning system. The positioning system (e.g. a global positioning system (GPS), a network address (IP address) positioning system, a positioning system based on the nearest cell tower location, or the like) may enable at least the wearable device 140 or an external server or computing device in communication with the wearable device 140 to determine the location (e.g. location coordinates) of the wearable device 140.

Each processor described herein, including the processor 144, generally includes circuitry for implementing the audio, visual, and/or logic functions of the wearable device 140. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the wearable device application 147 of the memory 146 of the wearable device 140.

Each memory device described herein, including the memory 146 for storing the wearable device application 147 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system. In this regard, the system may utilize the volatile memory over the non-volatile memory by storing multiple pieces of information in the volatile memory, thereby reducing the load on the system and increasing the processing speed.

As shown in FIG. 1, the memory 146 includes the wearable device application 147. In some embodiments, the wearable device application 147 includes an interface for communicating with, navigating, controlling, configuring, and/or using the wearable device 140. In some embodiments, the wearable device application 147 includes computer-executable program code portions for instructing the processor 144 to perform one or more of the functions of the wearable device application 147 described and/or contemplated herein. In some embodiments, the wearable device application 147 may include and/or use one or more network and/or system communication protocols.

FIG. 1 depicts an embodiment of the invention wherein a secure token chip 148 is provided on the wearable device for secure storage and retrieval of token(s) associated with the wearable. The secure token chip 148 is a hardware element that stores the token(s) with security features that restricts access to the token(s) and requires secure communications (encryption, secure codes, etc.) with the secure token chip 148 to access the token(s) stored therein. The token(s) may be hard-coded into the secure token chip 148 such that the token cannot be changed or removed without removing or changing the hardware element of the secure token chip 148. Additionally, the wearable device 140 may store instructions in memory 147 directing the processor 144 how to communicate with the secure token chip 148 to receive the token(s) stored therein. As will be discussed later below, in some embodiments, the wearable device may not store the token(s) and may not include a secure token chip. In this embodiment, the token(s) may be stored in a remote secure server, such as a secure cloud. In this embodiment, the memory 147 comprises software that is operable by a processor 144 to request the token(s) remotely from the secure server and pass the token(s) to a transaction machine for a transaction. In this embodiment, the wearable device does not store or otherwise retain the token(s) post-transaction. As such, in either embodiment, the token(s) is securely maintained.

Also shown in FIG. 1 is the user interface 149. In some embodiments, the user interface 149 includes one or more output devices, such as a display and/or speaker, for presenting information to the user. In some embodiments, the user interface 149 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user. In some embodiments, the user interface 149 includes the input and display devices of a mobile device, which are operable to receive and display information.

FIG. 1 also illustrates a system 130, in accordance with an embodiment of the present invention. The system 130 may refer to the “apparatus” described herein. The system 130 may include any computerized apparatus that can be configured to perform any one or more of the functions of the system 130 described and/or contemplated herein. In accordance with some embodiments, for example, the system 130 may include a computer network, an engine, a platform, a server, a database system, a front-end system, a back end system, a personal computer system, and/or the like. Therefore, the system 130 may be a server managed by the business. The system 130 may be located at the facility associated with the business or remotely from the facility associated with the business. In some embodiments, such as the one illustrated in FIG. 1, the system 130 includes a communication interface 132, a processor 134, and a memory 136, which includes a system application 137 and a structured database 138 stored therein. As shown, the communication interface 132 is operatively and selectively connected to the processor 134, which is operatively and selectively connected to the memory 136.

The financial institution system 150 is connected to the network 110 and is configured to communicate with each of the other devices connected to the network 150. Particularly, the financial institution system 150 is configured to receive communications from the system 130 to perform transactions as defined herein. The financial institution system 150 may further include information relating to financial accounts and/or transaction history of the user. In some embodiments, the financial institution system 150 may be maintained by a financial institution, while in other embodiments, the financial institution system 150 may be managed by the manufacture of the wearable device. In such instances, the financial institution system 150 may include information about the wearable device and the user.

The environment 100 may also include a transaction device 160 that is in communication with the other devices on the network 110. The transaction machine may be configured to communicate with the system 130 and the wearable device 140 to complete the functions described herein. The transaction device 160 may further communicate with the wearable device over a communicable link established between the transaction device 160 and the wearable device 140 to complete transactions as defined herein.

It will be understood that the system application 137 may be configured to implement any one or more portions of the various user interfaces and/or process flow described herein. The system application 137 may interact with the wearable device application 147. It will also be understood that, in some embodiments, the memory includes other applications. It will also be understood that, in some embodiments, the system application 137 is configured to communicate with the structured database 138, the wearable device 140, or the like.

It will be further understood that, in some embodiments, the system application 137 includes computer-executable program code portions for instructing the processor 134 to perform any one or more of the functions of the system application 137 described and/or contemplated herein. In some embodiments, the system application 137 may include and/or use one or more network and/or system communication protocols.

In addition to the system application 137, the memory 136 also includes the structured database 138. As used herein, the structured database 138 may be one or more distinct and/or remote databases. In some embodiments, the structured database 138 is not located within the system and is instead located remotely from the system. In some embodiments, the structured database 138 stores information or data described herein.

It will be understood that the structured database 138 may include any one or more storage devices, including, but not limited to, datastores, databases, and/or any of the other storage devices typically associated with a computer system. It will also be understood that the structured database 138 may store information in any known way, such as, for example, by using one or more computer codes and/or languages, alphanumeric character strings, data sets, figures, tables, charts, links, documents, and/or the like. Further, in some embodiments, the structured database 138 may include information associated with one or more applications, such as, for example, the system application 137. It will also be understood that, in some embodiments, the structured database 138 provides a substantially real-time representation of the information stored therein, so that, for example, when the processor 134 accesses the structured database 138, the information stored therein is current or substantially current.

It will be understood that the embodiment of the system environment illustrated in FIG. 1 is exemplary and that other embodiments may vary. As another example, in some embodiments, the system 130 includes more, less, or different components. As another example, in some embodiments, some or all the portions of the system environment 100 may be combined into a single portion. Likewise, in some embodiments, some or all the portions of the system 130 may be separated into two or more distinct portions.

In addition, the various portions of the system environment 100 may be maintained for and/or by the same or separate parties. It will also be understood that the system 130 may include and/or implement any embodiment of the present invention described and/or contemplated herein. For example, in some embodiments, the system 130 is configured to implement any one or more of the embodiments of the process flows described and/or contemplated herein in connection any process flow described herein. Additionally, the system 130 or the wearable device 140 is configured to initiate presentation of any of the user interfaces described herein.

Once authenticated, the user may approach a point-of-sale terminal of a merchant and use the wearable device as a form of payment vehicle to execute the transaction. Since the wearable device has been pre-authenticated by the user and is determined to have remained in continual possession of the user since authentication, the user may be provided with the convenience of using the wearable device as a digital key (i.e. one touch operation) to execute the transaction without the need to provide additional identification information or authentication credentials at a point-of-sale terminal of a merchant. Further, this sense of security also transfers to the merchants who accept transactions using such a wearable device. The pre-authentication and possession monitoring of the wearable device provides the merchant with an increased level of confidence and thus reducing the likelihood of misrepresentation.

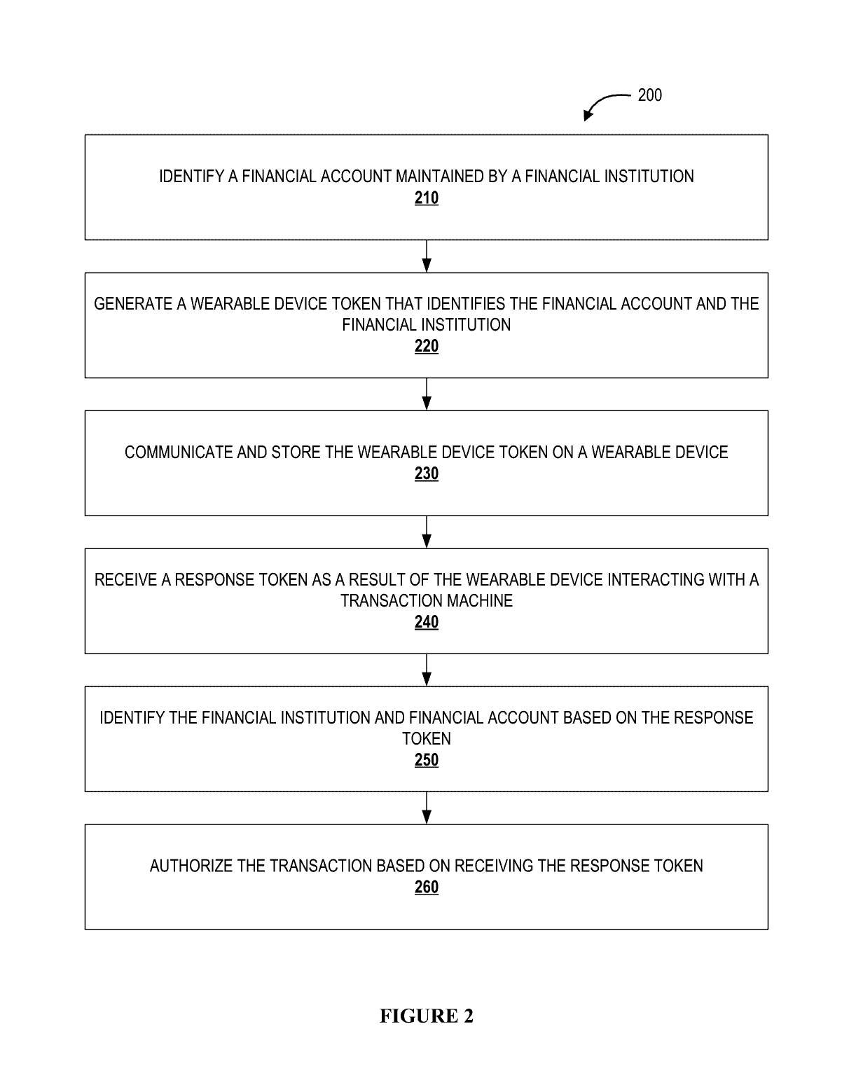

Referring now to FIG. 2, a process flow 200 is presented for authorizing a financial transaction based on receiving a wearable device token, in accordance with various embodiments of the present invention.

As illustrated in block 210, the system is configured to identify a financial account maintained by a financial institution. The financial account is associated with a transaction card used to conduct transactions using the financial account. Typically, the account is used by a user to conduct financial transactions using a transaction card. The transaction card may be, but is not limited to, a debit card, a credit card, and the like. The transaction card may have a magnetic strip or another storage device contained therein that stores information related to the financial account. Typically, the information relates to an account number and other information necessary to identify the account and the financial institution that maintains the account. The transaction card may have a Personal Identification Number (PIN) that a user may enter prior to completing a transaction using the transaction card.

As illustrated in block 220, the system is configured to generate a wearable device token that identifies the financial account and the financial institution. In some embodiments, the system may generate a random hash that is stored in memory and associated with the information of the financial account and the financial institution. The hash is then communicated as the wearable device token. Therefore, if the hash is discovered through unauthorized channels, the hash does not reveal any information about the financial account and/or financial institution. The system is capable of parsing the hash and performing a lookup of the financial account and financial institution stored in memory using the hash. In other embodiments, the wearable device token may include an encrypted version of the financial account and the financial institution. After generating the wearable device token, the system may be configured to communicate the wearable device token to a wearable device associated with a user of the financial account for storage on the wearable device, as described in Block 230.

In some embodiments of the invention, such as depicted in FIG. 1, the system comprises a secure token chip 148 that securely stores the token(s) on the wearable device. The secure token chip requires a secure channel, secure communication, and secure code for access of the token(s), such that the token(s) is maintained in the wearable device in a secure manner. Further, the token(s) typically may not be manipulated or updated except by removal and replacement of the hardware element. In this embodiment, the wearable device includes software stored in memory capable of performing a secure communication with the secure token chip to retrieve the token(s) for use in a transaction. A processor on the wearable device receives the token(s) from the secure token chip and then transmits such token(s) using a secure communication link to the transaction machine, such that the token(s) is securely maintained during the transaction process.

In other embodiments of the invention, the token(s) may not be maintained on the wearable device but in a remote secure server or cloud. In these instances, the wearable device may include software stored in memory for communicating with the remote server to retrieve the token(s) for a given transaction and communicate the token(s) to a transaction device. All communication of the token(s) is handled through secure communications to maintain the security of the token. Further, following the transaction, the wearable device does not retain the token(s) in memory, thereby reducing security issues associated with access to the token(s), as the token(s) is not persistently stored on the wearable device.

In some embodiments, the wearable device may be paired with an auxiliary device, such as a mobile phone of the user. The token(s) could be stored on in a secure token chip on the auxiliary device or again a remote server. In this embodiment, the pairing connection between the wearable device and the auxiliary device provides an added layer of authentication and security, as both devices have been preregistered with the system as being associated with the user. During a transaction, the wearable device may operate in conjunction with the auxiliary device to retrieve the token(s) either from: (i) a secure token chip stored on one or both the wearable and auxiliary devices; or (ii) a remote server or cloud and provide the token(s) to the transaction machine. As an added feature, the pairing connection between the wearable device and the auxiliary device may be used as part of the transaction process to maintain security. For example, if the pairing connection is severed or broken during the transaction process, the system may abort the transaction and remove the token(s) from memory. If the pairing connection is maintained between the wearable device and the auxiliary device, then one of the devices may communicate the token(s) to a transaction machine for completing a transaction.

Block 240 illustrates the system being configured to receive a response token as a result of the wearable device interacting with a transaction machine to complete a transaction. The response token includes information relating to the wearable device token. Generally, the wearable device is configured to generate the response token. The wearable device configuration may be at least in part due to an application associated with the system that is installed on the wearable device. Thus, the application is capable of directing the wearable device to perform instructions for integrating with the system and other devices to perform the steps contained herein. Causing the wearable device to generate the response token may be based on the wearable device token. Where the wearable device token is a hash, the response token may be a copy of the wearable device token. In other embodiments, the response token may be an encrypted version of the wearable device token. In other embodiments, the response token may contain more than the wearable device token. For example, the response token may include information about the transaction machine, the wearable device, and details of the transaction. In some embodiments, the application may cause the wearable device to communicate with a transaction machine. The transaction machine may be an automated teller machine (ATM), or a merchant point-of-sale device. The transaction machine may further include other types of machines that may be used to aid a user in completing a financial transaction. Additionally, such machines may be configured to communicate with a wearable device. The interaction between the wearable device and the transaction machine may be completed using a wired or wireless connection. A wireless connection may be made using short range RF, Bluetooth, Near Field Communication (NFC), and the like. As an exemplary embodiment, of the invention, the wearable device and the transaction machine may include a NFC transmitter. The user places the wearable device near the transaction machine and the transaction machine and the wearable device create the connection. The application may then cause the wearable device to transmit the response token to the transaction machine.

As illustrated in block 250, the system is configured to identify the financial institution and the financial account based on the response token. Where the wearable device token is a hash and the response token contains the hash, the system may perform a lookup of the information associated with the hash. Where the response token contains an encrypted form of the wearable device token, the system decrypts the response token before identifying the institution and the financial account. Where the response token contains information in addition to the wearable device token, the system may parse that information to perform additional function, as described herein. For example, the response token may include an identifier of the wearable device and the transaction machine. The system may determine that the transaction is subject to a limitation where the transaction must be completed by a limited set of transaction machines. The system may determine whether the transaction machine used, based on the transaction machine identifier, matches one of the limited set of transaction machines. The system may determine that the transaction machine is part of the limited set of transaction machines and proceed accordingly.

Block 260 illustrates the system being configured to perform the transaction based on receiving the response token. To perform the transaction, the system may integrate with financial institution servers to request the transaction be performed. In other embodiments, the system may have the capability to perform the transaction directly.

In some embodiments of the invention, the user may have more than one financial account to perform financial transactions. In such an embodiment, the system may be configured to generate two or more wearable device tokens for each of the financial accounts. Each of the wearable device tokens identify the separate financial accounts of the user and further identify a financial institution for each of the separate financial accounts. For example, the user may have a checking account with Bank A and a credit account with Bank B. The system may generate tokens for each of these accounts and the first token would identify the checking account and Bank A. The second token would identify the credit account and Bank B. There is no limit to the number of tokens the system may generate. After generating the wearable device tokens, the system may then communicate the two or more wearable device tokens to the wearable device of the user.

In some embodiments of the invention, the system may be configured to enable the user to select one of the wearable device tokens to complete a transaction. In some embodiments, to enable the user the system may be configured to transmit and install an application on the wearable device. The application contains code that is executed by the wearable device to perform the functions described herein. The code may cause the wearable device to display a graphical user interface to the user. The graphical user interface may include a list of all the wearable device tokens available to the user. The code may further cause the wearable device to receive input from the user using user input controls. Using these user input controls, the user may select the desired wearable device token for completing the transaction. In addition to the wearable device tokens, the graphical user interface may additional display information relating to the financial account and the financial institution of the wearable device tokens. In other embodiments of the invention, the system may enable the user to select the wearable device token by generating a graphical user interface that is communicated to a computing device accessible by the user. For example, the graphical user interface may be a web page that is displayed via a browsing application installed on the computing device. The user is enabled to select the appropriate wearable device token. Further, the graphical user interface may communicate the selected wearable device token of the user to the system that in turn may communicate such to the wearable device. In other embodiments, the user may be able to select the wearable device token that is communicated to the system. The wearable device may only include a single wearable device token that is associated with all the financial accounts of the user. When the user interfaces with the transaction machine, the wearable device communicates the sole wearable device token. The system receives the wearable device token and based on receiving the selected wearable device token as a result of the user selecting such token using the graphical user interface, the system determines the appropriate financial account to user to complete the transaction. Yet in other embodiments, the system may petition the user to select the appropriate account to user after the system has received the wearable device token.

After the system receives the response token, the system may then complete the transaction.

In other embodiments of the invention, the application stored on the wearable device may further cause the wearable device to sense that the user physically possesses the wearable device. The wearable device may sense that the user physically possesses the wearable device based on the wearable device monitoring actions performed by the user. Some wearable devices include sensors that allow the wearable device to sense actions of the user. These sensors may include, but are not limited to, a camera, a temperature sensor, an accelerometer, a global positioning system (GPS) device, and the like. The application stored on the wearable device may instruct the wearable device to monitor the actions of the user to sense that the user physically possesses the wearable device. For example, the wearable device might include a biometric scanner that is configured to read the fingerprint of an individual that possesses the wearable device. The application stored on the wearable device may prompt the user to scan a fingerprint of the user. The application may then compare the scanned digital copy of the finger against a stored copy of the fingerprint to authenticate the user. If the user is authenticated based on such a comparison, the system communicates an indication to the system that the user physically possesses the wearable device, which the system receives. The system may further perform the transaction based on receiving this indication.

In another embodiment of the invention, the system is configured to receive authentication credentials. The system may use these authentication credentials to authenticate the user prior to completing the transaction. In some embodiments, the authentication credentials are received as a result of the user supplying the authentication credentials to a transaction machine. For example, the transaction machine may be an Automated Teller Machine (ATM) and after the user interfaces the wearable device with the ATM, the ATM prompts the user to supply a Personal Identification Number (PIN) using a keypad of the ATM. The user supplies the PIN, and the ATM communicates the PIN to the system that authenticates the PIN and the user. Based on such an authentication, the system may perform the transaction.

In other embodiments of the invention, the system may be configured to register the wearable device as being associated with the wearable device token. Such a registration may be based on a unique identification associated with the wearable device. The unique identification may be any identification that is unique to the wearable device. This identification may be associated with the wearable device by the manufacture and may include a serial number and the like. In some embodiments, the unique identification may be assigned to the wearable device by the system after the system generates the unique identification. The application stored on the wearable device may receive and store the unique identification. When the user desires to perform a transaction and interfaces the wearable device with a transaction machine, the system may authenticate the wearable device using the unique identification associated with the wearable device. The wearable device may communicate the unique identification or a form of the unique identification. In the case that the wearable device communicates a form of the unique identification, the system may be configured to parse the form and compare such with the unique identification. Thus, the system may authenticate the wearable device. Thus, only wearable device that have been registered may be used to complete transactions. In the event a response token is received from a wearable device that has not been registered, the system may deny a performance the transaction.

In other embodiments of the invention, the wearable device token may be a single-use token. After the system generates such a single-user token, the system may track whether a response token that includes information of the single-use token has been received to perform a transaction. When the system receives the single-use token and performs the transaction, the system may reference the single-use token as being complete. If the system were to receive a second response token that includes information relating to the single-user token, the system may deny performing the transaction.

In another embodiment of the invention, the wearable device token may have an associated limitation restricting performance of a transaction. The limitation may be related to an amount of the financial transaction. For example, the limitation may restrict transactions over $100 to be performed. The limitation may further restrict a total amount of the transactions that may be performed in a given time period. The limitation may be further restricted to a geographical location or transaction machines that are associated with a given network. Where the limitation is based on a geographic location, the wearable device may communicate the location of the wearable device. The location may be determined by the wearable using standard techniques. These techniques may include, but is not limited to, GPS, WiFi triangulation, and the like. The system may determine whether the transaction is subject to the limitation. If the transaction is not subject to the limitation, the system may perform the transaction. For example, the limitation may restrict the user from withdrawing more than $100 a week from a financial account. The system determines that the user has withdrawn $80 within the week and is attempting to withdraw another $30. The system may determine that the transaction is not within the limitation and may decline the transaction.

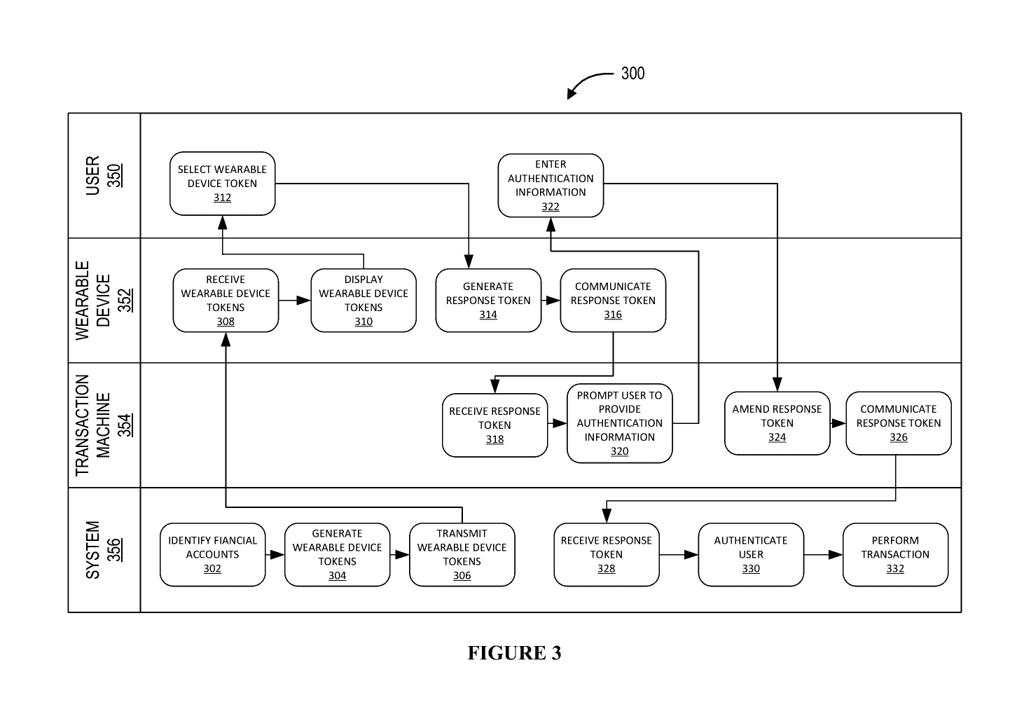

FIG. 3 illustrates a mixed block and flow diagram of an apparatus 300 for authorizing a financial transaction based on receiving a wearable device token, in accordance with several embodiments of the present invention. As shown, the apparatus 300 includes a user 350, a wearable device 352, a transaction machine 354, and a system 356. It should be understood that the apparatus the wearable device 352, the transaction machine 354, and the system 356 are all operatively connected to each other via a common distributed network and each device or system is capable of communicating with every other device or system via the network. It should be further understood that the user 350 is capable of interacting with the wearable device 352 and the transaction machine 354 as necessary to perform the actions defined herein. The user 350, the wearable device 352, the transaction machine 354, and the system 356 will all have their common definitions, as defined herein, unless otherwise specified.

As illustrated in block 302, the system 356 identifies financial accounts of a user, where each of the financial accounts is maintained by a financial institution. The user may be an owner or co-owner of the account, a beneficiary of the account, a trustee of the account, or a manager of the account. The financial accounts typically have a transaction card associated with the account that may be used by the user to conduct transactions using funds of the account.

As illustrated in block 304, the system 304 generates a wearable device token for each of the accounts. The wearable device tokens each identify the financial account and the financial institution that are associated with the wearable device token.

In block 306, the system 356 communicates the wearable device tokens to the wearable device 352. The system 356 may communicate the wearable device tokens over the distributed network. The wearable device 352 receives the wearable device tokens, as illustrated in block 308.

In block 310, the wearable device 352 may, using an installed application that is associated with the system 356, generate and display a graphical user interface to present the wearable device tokens to the user 350. The wearable device 352 may further display the financial accounts and the financial institutions associated with the wearable device tokens. The wearable device 352 may further enable the user 350 to select one of the wearable device tokens that the user desires to use to complete a transaction.

In block 312, the user 350 interacts with the wearable device 352 to select one of the wearable device tokens, which is recorded by the wearable device 352. Using the selected wearable device token, the wearable device 352 generates a response token based, as illustrated in block 314. The response token may be generated using the wearable device token and may include information relating to the wearable device token.

As illustrated in block 316, the wearable device 342 may communicate the wearable device token to the transaction machine 354. Communicating the wearable device token may be accomplished over a communicable link formed between the wearable device 352 and the transaction machine 354. The communicable link may be either wired or wireless. Wireless communicable links may include, but are not limited to, short range RF communications, Bluetooth, WiFi, Near Field Communication (NFC) and the like. The transaction machine receives the response token, as illustrated in block 318.

As illustrated in block 320, the transaction machine 354 may prompt the user 350 to provide authentication credentials to authenticate the user 350. The user 350 may enter the authentication credentials using an input device of the transaction machine 354 (e.g. keypad or touchscreen). The user 350 entering the authentication credentials is illustrated in block 322.

Based on the authentication credentials, the transaction machine 354 may amend the response token to include the authentication credentials. The transaction machine 354 may then communicate the amended response token to the system 356. The system 356 receives the response token, as is illustrated in block 328.

The system 356 in block 330 parses the response token to acquire the authentication credentials. Using these authentication credentials, the system 356 may authenticate the user.

In other embodiments, the system 356 may further parse information about the financial account, the financial institution, and the transaction from the response token. Using this information, the system 356 may then perform the transaction, as is illustrated in block 332.

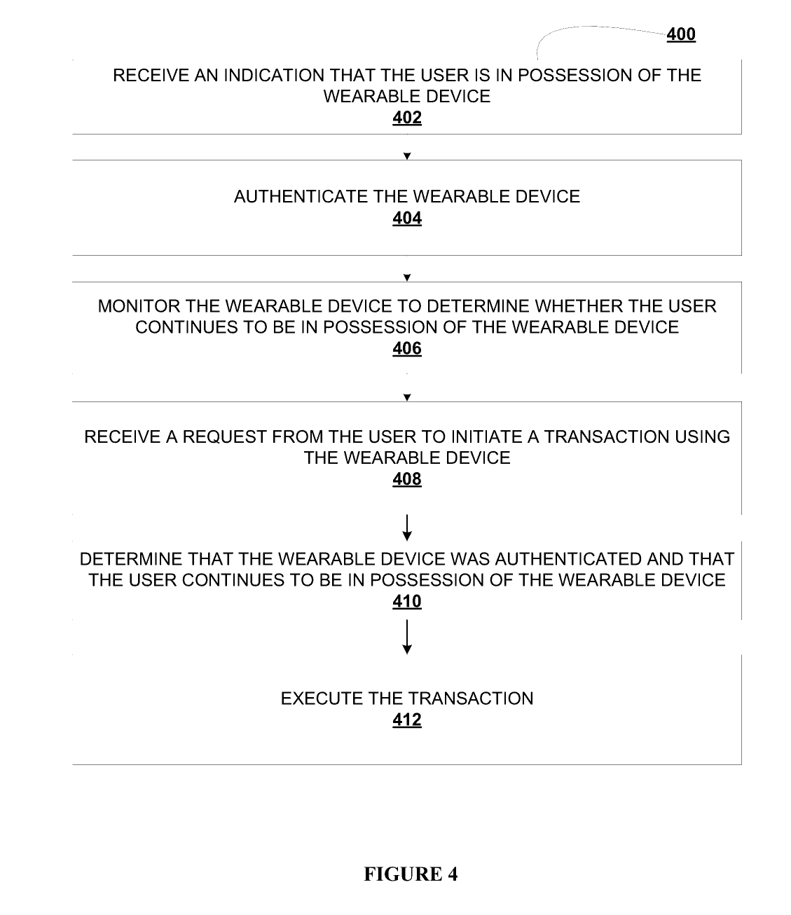

FIG. 4 illustrates a process flow for authenticating a wearable device, in accordance with an embodiment of the invention. As shown in block 402, the process flow includes receiving an indication that the user is in possession of the wearable device. Typically, the wearable device comprises one or more sensors configured to gather physiological and/or movement data to enable monitoring and possession of the wearable device by the user. The data gathered using the wearable device may be transmitted either to an auxiliary device (e.g. personal computing device, mobile device, or the like) or to an online storage site. The variety of sensors may be attributed to the types of stimuli that they correspond to (e.g., physiological vital signs, temperature, body movements, organic substances, or the like) and their placements (clothing, body part accessory, subcutaneous implant, or the like). In this way, the system may be configured to determine whether the user is in possession of the wearable device.

Next, as shown in block 404, process flow includes authenticating the wearable device. Typically, authenticating a wearable device may comprise sending an authentication request to the financial institution to associate (e.g., enroll) the wearable device with the user's online banking account. In this regard, the system may be configured to receive an authentication request from the user. The authentication request may be submitted by the user using the wearable device directly, or an auxiliary device previously paired to the wearable device. Typically, the wearable device may be securely paired with an auxiliary device by establishing a secure channel between the two unassociated devices over a short-range wireless communication channel. In this way, a secure communicable link is created between the wearable device and the auxiliary device utilizing system application directives.

The authentication request includes device information associated with the wearable device and user information associated with the user and user's online banking account. The device information associated with the wearable device may be any information sufficient to generate a device “fingerprint”, or a unique signature of the user's wearable device. The user information may be any information sufficient to identify the user and the user's online banking account. In some embodiments, the user information may include, but is not limited to, at least one of a username, contact information, a password, a PIN number, biometric information (e.g., physiological features such as fingerprints, finger vein and palm vein patterns, as well as iris and facial recognition to verify individual identities), a unique identification number associated with the user, social network information, an account number, or a card number. In some embodiments, the user information may be proprietary to the financial institution, such as an account number, a reference number to an account, a client number, or the like. In other embodiments, the user information may be public information, such as a phone number, mailing address, email address, or the like.

Next, as shown in block 404, the process flow includes authenticating the wearable device. In this regard, the system may be configured to associate the wearable device with the user. This association is based on comparing or matching the device information associated with the wearable device with user information associated with the user and user's online banking account. In doing so, the user may be authorized to access the online banking account using the wearable device to execute one or more transactions.

In some embodiments, the wearable device may be paired with an auxiliary device associated with the user. In these instances, the system may be configured to receive the authentication request from the user via an application or via a banking website downloadable on the auxiliary device. In this regard, the system may be configured to receive one or more authentication credentials from the user via the auxiliary device and authenticate the user based on the received authentication credentials. In response to successfully authenticating the user and the auxiliary device, the system may automatically authenticate the wearable device paired or communicably linked to the auxiliary device.

Next, as shown in block 406, the process flow includes monitoring the wearable device to determine whether the user remains in possession of the wearable device. In this regard, the system may be configured to monitor the variety of sensors associated with the wearable device and the stimuli that they correspond to (e.g., physiological vital signs, temperature, body movements, organic substances, or the like). In some embodiments, the sensors may be monitored periodically to determine possession. In instances where the wearable device is paired with an auxiliary device, the system may be configured to monitor the auxiliary device and determine whether the mobile device continues to be paired to the wearable device. In this regard, the wearable device may be monitored based a determined location of the auxiliary device paired to the wearable device using global positioning data, such as accessing auxiliary device global positioning systems (GPS) or the like. Global positioning data may include any information collected from methods, systems, apparatus, computer programs, or the like involving locating a position of the user's auxiliary device relative to satellites, fixed locations, beacons, transmitters or the like. In some instances, global positioning data may be collected from a GPS device, such as a navigation system. Such a navigation system may be, but is not limited to, hardware and/or software that is part of the auxiliary device. In response to determining the location of the auxiliary device and further determining that the auxiliary device is still paired with the wearable device, the system may be configured to determine that the user remains in possession of the wearable device. In some embodiments, both the auxiliary device and the wearable device may be concurrently monitored to determine that the user remains in possession of the wearable device.

Next, as shown in block 408, the process flow includes receiving a request from the user to initiate a transaction using the wearable device. In some embodiments, the user may use the wearable device at a point-of-sale terminal of a merchant to execute a transaction. In this regard, the user may transmit an indication to execute a transaction using the wearable device. By way of example, the user may scan the wearable device at the point-of-sale of the merchant to execute a purchase. In this regard, the user may transmit a transaction request to the financial institution to initiate the execution of the purchase. The transaction request provided by the user may include, but not be limited to, the transaction type, the transaction amount, the transaction account, one or more related accounts, the transaction request date, and the like. In some other embodiments, the user may use the wearable device to execute other financial transactions such as, but not limited to, receiving statements related to an account history, processing automated teller machine (ATM) transactions, transferring funds from domestic or international accounts, process commercial payments related to online bill-pay, peer-to-peer payments, account withdrawals, account deposits, and/or the like.

Next, as shown in block 410, the process flow includes determining that the wearable device was authenticated and that the user remains in possession of the wearable device. In some embodiments, the wearable device may only have to be authenticated once at a first time stamp. The wearable device may then be continuously monitored to determine whether the user remains in possession of the wearable device from the first time stamp when the wearable device is authenticated until a second time stamp when receiving the request to initiate a transaction. In instances where the wearable device is paired with an auxiliary device, the system may determine the location of the auxiliary device and then determine whether the auxiliary device remains paired with the wearable device. In response, the process flow includes executing the transaction, as shown in block 412.

Any of the features described herein with respect to a particular process flow are also applicable to any other process flow. In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Additionally, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions that execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for authorizing a financial transaction based on receiving a wearable device token, wherein the system comprises:
a memory;
a communication interface;
one or more processors; and
a module stored in memory, wherein the module comprises code executable by the one or more processors, wherein the code, when executed by the one or more processors, causes the one or more processors to:
identify a financial account maintained by a financial institution, wherein the financial account is associated with a transaction card used to conduct transactions using the financial account;
generate a wearable device token that identifies the financial account and the financial institution;
communicate the wearable device token to a wearable device associated with a user of the financial account for storage on the wearable device;
receive a response token as a result of the wearable device interacting with a transaction machine to complete a transaction, wherein the response token comprises information related to the wearable device token;
identify the financial institution and the financial account based on the response token; and
perform the transaction based on receiving the response token.

2. The system of claim 1, wherein the user is associated with multiple financial accounts, wherein the code further comprises instruction code configured to cause the one or more processors to:
generate two or more wearable device tokens that each identifies separate accounts of the user and a financial institution for each of the separate accounts;
communicate the two or more wearable device tokens to the wearable device associated with the user;
enable the user to select one of the two or more wearable device tokens to complete the transaction;
receive a response token comprising information related to the selected wearable device token, wherein receiving the response is a result of the wearable device interacting with the transaction machine to complete a transaction; and
perform the transaction based on receiving the response token comprising information related to the selected wearable device token.

3. The system of claim 1, wherein the code further comprises instruction code configured to cause the one or more processors to:
transmit code executable by the wearable device that causes the wearable device to:
sense the user physically possesses the wearable device, wherein sensing the user physically possesses the wearable device is based on the wearable device monitoring actions performed by the user; and
communicate an indication that the user physically possesses the wearable device;
receive the indication that the user physically possesses the wearable device, and
wherein performing the transaction is further based on determining that the user physically possesses the wearable device.

4. The system of claim 1, wherein the code further comprises instruction code configured to cause the one or more processors to:
receive, from the transaction machine, an authentication credential, wherein the authentication credential is received as a result of the user entering in the authentication credential to the transaction machine;
authenticate the user using the authentication credential; and
perform the transaction based on authenticating the user.

5. The system of claim 1, wherein the code further comprises instruction code configured to cause the one or more processors to:
register the wearable device as associated with the wearable device token based at least on a unique identification associated with the wearable device;
authenticate the wearable device when receiving the response token using the unique identification associated with the wearable device; and
perform the transaction based on authenticating the wearable device.

6. The system of claim 1, wherein the wearable device token is a single-use token, wherein the code further comprises instruction code that causes the one or more processors to:
receive a second response token comprising information related to the single-use token, wherein the second response token is received after performing the transaction; and
cancel a second transaction associated with the second response token based on receiving the second response token after performing the transaction.

7. The system of claim 1, wherein the wearable device token has an associated limitation restricting performance of the transaction, and wherein the code further comprises instruction code configured to cause the one or more processors to:
determine whether the transaction is subject to the limitation; and
perform the transaction if the limitation does not apply.

8. A computer program product for authorizing a financial transaction based on receiving a wearable device token, the computer program product comprising a computer readable storage medium having computer readable program code embodied therewith, the computer readable program code being configured to cause one or more processors to:
identify a financial account maintained by a financial institution, wherein the financial account is associated with a transaction card used to conduct transactions using the financial account;
generate a wearable device token that identifies the financial account and the financial institution;
communicate the wearable device token to a wearable device associated with a user of the financial account for storage on the wearable device;
receive a response token as a result of the wearable device interacting with a transaction machine to complete a transaction, wherein the response token comprises information related to the wearable device token;
identify the financial institution and the financial account based on the response token; and
perform the transaction based on receiving the response token.

9. The computer program product of claim 8, wherein the user is associated with multiple financial accounts, wherein the computer readable program code being further configured to cause the one or more processors to:
generate two or more wearable tokens that each identifies separate accounts of the user and a financial institution for each of the separate accounts;
communicate the two or more wearable device tokens to the wearable device associated with the user;
enable a user to select one of the two or more wearable device tokens to complete the transaction;
receive a response token comprising information related to the selected wearable device token, wherein receiving the response is a result of the wearable device interacting with the transaction machine to complete a transaction; and
perform the transaction based on receiving the response token comprising information related to the selected wearable device token.

10. The computer program product of claim 8, wherein the computer readable program code being further configured to cause the one or more processors to:
determine the user possesses the wearable device when receiving the response token; and
performing the transaction based on determining the user possesses the wearable device when receiving the response token.

11. The computer program product of claim 8, wherein the computer readable program code being further configured to cause the one or more processors to:
receive an authentication credential, wherein the authentication credential is received as a result of the user entering in the authentication credential to the transaction machine;
authenticate the user using the authentication credential; and
perform the transaction based on authenticating the user.

12. The computer program product of claim 8, wherein the computer readable program code being further configured to cause the one or more processors to:
register the wearable device as associated with the wearable device token based at least one a unique identification associated with the wearable device;
authenticate the wearable device when receiving the response token using the unique identification associated with the wearable device; and
perform the transaction based on authenticating the wearable device.

13. The computer program product of claim 8, wherein the wearable device token is a single-use token, wherein the computer readable program code being further configured to cause the one or more processors to:
receive a second response token comprising information related to the single-use token, wherein the second response token is received after performing the transaction; and
canceling a second transaction associated with the second response token based on receiving the second response token after performing the transaction.

14. The computer program product of claim 8, wherein the wearable device token has an associated limitation restricting performance of the transaction, and wherein the computer readable program code being further configured to cause the one or more processors to:
determine whether the transaction is subject to the limitation; and
perform the transaction if the limitation does not apply.

15. A computer implemented method for authorizing a financial transaction based on receiving a wearable device token, wherein the method comprising:
identifying a financial account maintained by a financial institution, wherein the financial account is associated with a transaction card used to conduct transactions using the financial account;
generating a wearable device token that identifies the financial account and the financial institution;
communicating the wearable device token to a wearable device associated with a user of the financial account for storage on the wearable device;
receiving a response token as a result of the wearable device interacting with a transaction machine to complete a transaction, wherein the response token comprises information related to the wearable device token;
identifying the financial institution and the financial account based on the response token; and
performing the transaction based on receiving the response token.

16. The computer implemented method of claim 15, wherein the user is associated with multiple financial accounts, wherein the method further comprises:
generating two or more wearable tokens that each identifies separate accounts of the user and a financial institution for each of the separate accounts;
communicating the two or more wearable device tokens to the wearable device associated with the user;
enabling a user to select one of the two or more wearable device tokens to complete the transaction;
receiving a response token comprising information related to the selected wearable device token, wherein receiving the response is a result of the wearable device interacting with the transaction machine to complete a transaction; and
performing the transaction based on receiving the response token comprising information related to the selected wearable device token.

17. The computer implemented method of claim 15, wherein the method further comprises:
determine the user possesses the wearable device when receiving the response token; and
performing the transaction based on determining the user possesses the wearable device when receiving the response token.

18. The computer implemented method of claim 15, wherein the method further comprises:
receive an authentication credential, wherein the authentication credential is received as a result of the user entering in the authentication credential to the transaction machine;
authenticate the user using the authentication credential; and
perform the transaction based on authenticating the user.

19. The computer implemented method of claim 15, wherein the method further comprises:
register the wearable device as associated with the wearable device token based at least one a unique identification associated with the wearable device;
authenticate the wearable device when receiving the response token using the unique identification associated with the wearable device; and
perform the transaction based on authenticating the wearable device.

20. The computer implemented method of claim 15, wherein the wearable device token is a single-use token, wherein the method further comprises:
receive a second response token comprising information related to the single-use token, wherein the second response token is received after performing the transaction; and
canceling a second transaction associated with the second response token based on receiving the second response token after performing the transaction.
